(19) United States
(12) Patent Application Publication
(10) Pub. No.: US 2022/0241722 A1
(43) Pub. Date: Aug. 4, 2022

(54) Hydrogen Sulfide Removal in Liquid and Gas Streams

(71) Applicant: Jiang Wan, Dupont, WA (US)

(72) Inventor: Jiang Wan, Dupont, WA (US)

(21) Appl. No.: 17/168,133

(22) Filed: Feb. 4, 2021

(51) Int. Cl. B01D 53/52; C02F 1/68; C02F 1/72; B01D 53/04

(52) U.S. Cl. CPC B01D 53/52; C02F 1/683; C02F 2101/101; B01D 53/04; C02F 1/72

(57) ABSTRACT

The invention relates to water-soluble and/or dispersible ferric hydroxide in a strong base that is suitable for hydrogen sulfide removal in contaminated liquid and gas streams. The water-soluble and/or dispersible ferric hydroxide in a strong base may be introduced into a liquid stream to remove hydrogen sulfide. The water-soluble and/or dispersible ferric hydroxide may be further incorporated into a solid substrate for gas phase hydrogen sulfide removal.

### FIELD OF THE INVENTION

This invention relates to compositions and methods of preparation for said compositions for the removal of hydrogen sulfide in contaminated liquid and gas streams, such as in wastewater collection systems and wastewater treatment facilities.

### BACKGROUND

Hydrogen sulfide is commonly found in wastewater collection systems and wastewater treatment facilities as a contaminant that is not only odorous but also toxic and corrosive. Fugitive hydrogen sulfide from manholes, pump stations, and treatment facilities result in odor complaints from the public. Workers who perform maintenance and operation activities face unsafe working conditions, and in severe cases, fatalities have occurred as a result of exposure to a high concentration of hydrogen sulfide gas. Hydrogen sulfide is responsible for widespread corrosion to the infrastructure and has led to sewer pipe collapse. It is a common practice for the wastewater industry to provide treatment in the liquid-phase and the gas-phase to mitigate the adverse effect of hydrogen sulfide.

In the space of liquid-phase treatment, it is known in the art to inject aqueous chemical solutions into the wastewater stream in the collection system to provide treatment. The aqueous solution of nitrate salts is known to inhibit the formation of sulfide. For example, U.S. Pat. No. 499,8,43 discloses the addition of nitrate salts in wastewater collection systems to prevent the formation of sulfide in the liquid phase. However, nitrate salts are not effective for the removal of sulfide after it is formed. The aqueous solution of strong oxidants, such as peroxide, peracetic acid, and hypochlorite, are known to oxidize sulfide in the liquid phase. However, these strong oxidants not only oxidize sulfide but also other constituents in wastewater, which may lead to the formation of undesirable by-products. Strong bases or alkaline, such as sodium hydroxide solution, magnesium hydroxide and calcium hydroxide slurries, are known to raise the pH of wastewater to keep hydrogen sulfide from gassing off. However, this type of treatment only keeps sulfide in the liquid phase but doesn't remove sulfide.

The aqueous solution of iron salts, such as ferrous and ferric salts, is also known in the art to remove hydrogen sulfide in the liquid-phase. Ferrous salt works by selectively reacting with sulfide at a molar ratio of 1:1 to form insoluble ferrous sulfide. Ferric salt works by first oxidizing sulfide to elemental sulfur which leads to the reduction of ferric to ferrous, followed by reaction with additional sulfide to form ferrous sulfide. The overall reaction between ferric and sulfide is at a molar ratio of 1:1.5 with high selectivity, which makes it one of the most effective and efficient methods to remove hydrogen sulfide.

While iron salt has been favorably used to remove hydrogen sulfide in the liquid-phase, there are drawbacks associated with its application. Iron salts solutions are highly acidic, which may lead to a drop in pH for the wastewater to be treated, a condition that is undesirable to prevent hydrogen sulfide from gassing off. Iron salts are known to function as coagulants in wastewater, which may lead to excessive solid production if the iron salts are not first reacted with sulfide.

In the space of gas-phase treatment, it is known to use solid scavengers in a packed bed to remove hydrogen sulfide. For odor control associated with hydrogen sulfide in wastewater collection systems and treatment facilities, the predominant choice of solid scavenger is activated carbon because of its effectiveness and fast rate of reaction, which is on the order of a few seconds. However, activated carbon is expensive to make, and therefore the operating cost for this type of treatment is high.

There is an ongoing need to improve the performance of treatment products based on iron chemistry. For liquid-phase treatment, it has long been recognized that synergistic effect may be achieved by combining conventional iron-based treatment with another known treatment method such as alkaline addition. For example, it was reported that the cost of iron salt addition was reduced by magnesium hydroxide addition (B. K. Reed and C. D. Dilon, ‘Enhancing Iron’, Water Environment and Technology, July 2012), but the addition of each product must be carried out separately with different chemical injection systems, which increases the capital cost of treatment. U.S. Pat. No. 5,948,269 discloses the combination of ferric salt and alkaline for sulfide treatment in the liquid-phase application. However, the combination of ferric salt and alkaline results in a solid product that is poorly mixing with and quickly settling out of wastewater to be treated, thus rendering hydrogen sulfide treatment ineffective.

### SUMMARY OF THE INVENTION

Accordingly, this invention discloses compositions and methods of preparation of said compositions, wherein said compositions possess combined performance attributes of conventional iron salt and alkaline for hydrogen sulfide removal in contaminated liquid and gas streams.

In accordance with one or more aspects, the disclosed compositions and products comprise water-soluble and/or dispersible ferric hydroxide in a strong base, wherein the particle size of said compositions may be less than 100 nanometers (nm). According to at least one embodiment, the water-soluble and/or dispersible ferric hydroxide in a strong base is produced through a two-step reaction, in which an aqueous solution of at least one ferric salt is first reacted with at least one organic compound containing both hydroxyl and carboxylic acid functional groups, followed by reaction with at least one strong base. The compositions are characterized by their favorable physical properties and chemical properties, including water solubility, long shelf life, low freezing point, selective and fast reaction with sulfide, and non-coagulating in wastewater. In yet another embodiment, the water-soluble and/or dispersible ferric hydroxide in a strong base is injected into a liquid stream that is contaminated with hydrogen sulfide, to advantageously raise the pH of the liquid stream and reactively remove hydrogen sulfide. Efficiencies and cost savings may be realized due to the dual function of the disclosed compositions.

In accordance with one or more aspects, the disclosed compositions comprise incorporating water-soluble and/or dispersible ferric hydroxide in a strong base into solid substrates. According to at least one embodiment, the water-soluble and/or dispersible ferric hydroxide in a strong base is incorporated into at least one biobased lignocellulose substrate and/or cellulose substrate, such as a wood substrate, to form a solid scavenger. In yet another embodiment, the solid scavenger may be packed in a column/fixed bed to remove hydrogen sulfide in contaminated gas streams.

### BRIEF DESCRIPTION OF THE DRAWINGS

FIG. 1 shows the reaction kinetics between nanosized ferric hydroxide and a sulfide solution

FIG. 2 compares hydrogen sulfide breakthrough in chemical scrubbing of hydrogen sulfide from biogas

FIG. 3 compares hydrogen sulfide breakthrough for activated carbon and nanosized ferric hydroxide impregnated into a biobased substrate

### DETAILED DESCRIPTION OF THE INVENTION

One or more embodiments relate generally to the treatment of hydrogen sulfide in contaminated liquid and gas streams, such as in wastewater collection systems and treatment facilities. For liquid phase application, the invention discloses compositions comprising water-soluble and/or dispersible ferric hydroxide in a strong base and methods for the preparation of said compositions. For gas-phase application, the invention discloses compositions comprising water-soluble and/or dispersible ferric hydroxide in a strong incorporated into solid substrates to form solid scavengers and methods for the preparation of said solid scavengers.

One or more embodiments relate generally to reaction products between iron salts, organic compounds containing both hydroxyl and carboxylic functional groups, and strong bases. The products may be prepared through a procedure described below, but modifications may be made without departing from the spirit of this invention. A first aqueous solution of iron salts is prepared at a concentration preferably ranging from 10 to 80% by weight, more preferably from 20 to 70%, most preferably from 30 to 60%, wherein the water-soluble iron salts may include iron chloride, iron sulfate, and iron nitrate; a second aqueous solution of water-soluble small organic molecules containing one or more hydroxyl and/or carboxylic functional groups at a concentration preferably ranging from 10 to 80% by weight, more preferably from 20 to 80%, most preferably from 40 to 80%, wherein the small organic molecules include hydroxyl acetic acid, tartaric acid, ascorbic acid, and gluconic acid; a third aqueous solution of a strong base at a concentration preferably ranging from 10 to 60% by weight, more preferably from 20 to 50%, most preferably from 30 to 50%, wherein the strong base includes sodium hydroxide, potassium hydroxide, lithium hydroxide; the first solution is mixed with the second solution at a molar ratio preferably from 1:10 to 10:1, more preferably from 1:5 to 5:1, most preferably from 1:2 to 2:1; the third solution is allowed to react with the above mixture to afford water-soluble and/or dispersible ferric hydroxide in a strong base.

Without wishing to be bound by any particular theory, the water solubility and/or dispersibility of ferric hydroxide is postulated to be attributable to the formation of nanosized ferric hydroxide particles, which are assisted and stabilized by the organic compounds containing hydroxyl and carboxylic function groups. The particle size distribution of a sample prepared in accordance with the above-described procedure is in the range of 11-77 nm. The particle size distribution analysis is conducted on a Malvern Zetasizer Nano ZS dynamic light scattering instrument, following ISO 22412:2008 Particle Size Analysis—Dynamic Light Scattering (DLS) and ASTM E2490-09 (2015) Standard Guide for Measurement of Particle Size Distribution of Nanomaterials in Suspension by Photon Correlation Spectroscopy (PCS).

In accordance with one or more embodiments, the nanosized ferric hydroxide in a strong base may be injected into liquid streams in wastewater collection systems to control hydrogen sulfide. Hydrogen sulfide control products used in liquid phase treatment generally fall into one of three main categories: inhibition of sulfide formation, reactive removal of sulfide after its formation, and elevation of pH to keep hydrogen sulfide from gas off. The disclosed compositions of nanosized ferric hydroxide in a strong base combines the performance attributes of two categories of products: reactive removal of hydrogen sulfide and pH elevation. The nanosized ferric hydroxide is responsible for fast and selective reaction with sulfide while the strong base is responsible for raising the pH of the liquid stream. Advantageously, a single product may be dosed into the wastewater collection system with a single chemical dosing system rather than two separate chemical dosing systems at two different sites as disclosed in prior arts to achieve the same level of treatment. Cost savings in both capital and operating expense may be realized as a result.

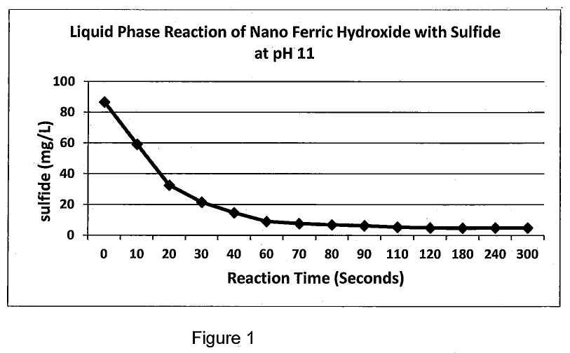

The reaction kinetics between nanosized ferric hydroxide and sulfide is shown in FIG. 1. In the experiment, a standard sulfide solution of 86 ppm is prepared and an equal molar ratio of nanosized ferric hydroxide is added to the solution. The reaction is followed with a Thermo Scientific Orion Silver/Sulfide combination ion-selective electrode, using a Thermo Scientific Orion 920A+ Advanced ISE/pH/MV/ORP meter with a BNC connection. The reaction is near completion after 60 seconds, with >90% reductions in sulfide concentration.

To demonstrate the superior performance of disclosed compositions to existing products, a laboratory-scale experiment is described. Wastewater samples are taken from a wastewater treatment plant and dissolved sulfide concentration is measured. Aliquots of 250 ml wastewater samples are transferred into BOD bottles and are dosed with magnesium hydroxide slurry, sodium hydroxide solution, nanosized ferric hydroxide, and ferric chloride solution respectively, at an equal molar ratio to dissolved sulfide. Gas-phase hydrogen sulfide is monitored qualitatively using lead acetate impregnated filter paper which is placed above the opening of the BOD bottles. The result showed that nano ferric hydroxide is most effective in controlling sulfide as indicated by almost no color change on the lead acetate paper. In comparison, wastewater samples treated with the other conventional products all showed variable shades of black colors on the lead acetate paper.

In accordance with one or more embodiments, the disclosed compositions overcome the drawbacks associated with conventional iron salt which tends to act as a coagulant if not first reacted with sulfide. Such products may be advantageously dosed into the wastewater collection systems to control hydrogen sulfide without concerns for excessive solid production. To demonstrate this, two of three 50 ml wastewater samples were added 10 microliters of 45% ferric chloride solution and 10 microliters of nanosized ferric hydroxide respectively, and the third sample was used as control. Total suspended solids (TSS) were measured after a contact time of one hour. The nanosized ferric hydroxide treated sample has a TSS of 204 ppm, which is the same as the control sample, while the ferric chloride treated sample has a TSS of 226 ppm, which represents an 11% increase in solid production.

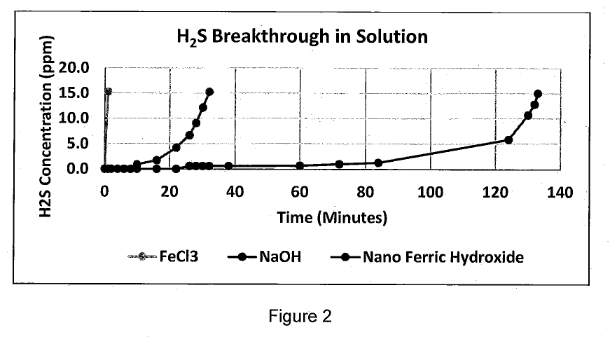

In accordance with one or more embodiments, the nanosized ferric hydroxide in a strong base may be used to chemically scrub hydrogen sulfide from biogas produced in anaerobic digesters. In a laboratory-scale trial, a bubbler filled with 100 mml scrubbing solution is connected to digester gas at a wastewater treatment plant at a flow rate of 100 ml/minute. The concentration of hydrogen sulfide is measured continuously from the outlet of the bubbler with a hydrogen sulfide data logger until a breakthrough concentration of 15 ppm is reached. As shown in FIG. 2, the ferric chloride solution showed almost immediate breakthrough while the breakthrough for sodium hydroxide solution didn't occur until after 30 minutes. In comparison, the breakthrough for nano ferric hydroxide in a strong base didn't occur until after 130 minutes.

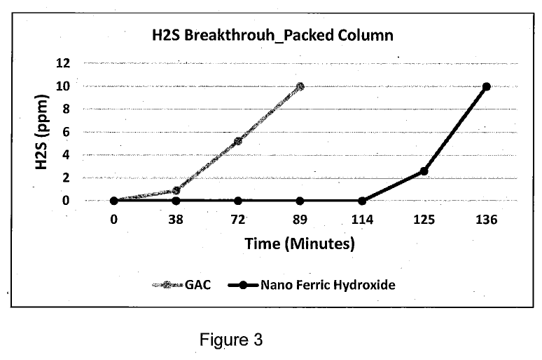

In accordance with one or more embodiments, the nanosized ferric hydroxide may be incorporated into a solid substrate to form a solid scavenger, wherein the solid scavenger may be used to remove hydrogen sulfide from contaminated gas streams. Surprisingly, solid scavengers prepared by incorporating nanosized ferric hydroxide into lignocellulose or cellulose biobased substrates, wherein the biobased substrates include wood, crop hulls, husks, stalks, coconut shells, and other plant-derived organic matters, were found to possess high removal capacity for hydrogen sulfide at fast reaction rate equivalent to activated carbon when evaluated under the same test conditions. FIG. 3 is the comparison between nano ferric hydroxide impregnated wood shavings and a high capacity GAC for gas-phase hydrogen sulfide removal. The evaluation follows ASTM D6646-03, Standard Method for Determination of the Accelerated Hydrogen Sulfide Breakthrough Capacity of Granular and Pelletized Activated Carbon. For the gas-phase treatment of hydrogen sulfide in the wastewater collection systems and treatment facilities, activated carbon has been and remains to be the solid scavenger of choice in packed/fixed-bed treatment systems. The favorable performance attribute provided by activated carbon is attributed to its highly porous structure and extremely high surface area. The biobased substrate, on the other hand, has a very low surface area and non-porous structure. The fact that a solid scavenger made with a biobased substrate has equivalent hydrogen sulfide removal capacity to activated carbon is unexpected. Activated carbon is produced in an energy-intensive process and thus is expensive. The disclosed compositions may bring about substantial economic and environmental benefits to gas stream treatment.

### EXAMPLE 1

The first solution of 40% ferric chloride is prepared by dissolved 40 g anhydrous ferric chloride in 100 g water. The second solution of 50% gluconic acid is prepared by dissolving 50 g gluconic acid in 100 g water. The first solution is mixed with the second solution in a molar ratio of between 1:0.5 to 1:2. The third solution of 40% sodium hydroxide is prepared by dissolving 40 g sodium hydroxide in 100 g water. Sodium hydroxide solution is added to the mixture of ferric chloride and gluconic acid until a water-soluble dispersion is obtained.

### EXAMPLE 2

70 ml of products prepared in Example 1 is mixed with 70 ml 10N sodium hydroxide solution. The mixture is added to 400 ml shredded wood and dried in an oven at 100° C. for 2 hours. Its hydrogen sulfide breakthrough capacity is measured following ASTM D 6646-3.

While particular embodiments of the compositions, products, and methods for the preparation of said compositions and products have been shown and described, it will be appreciated by those skilled in the art that changes and modifications may be made without departing from the inventions in its broader aspects and as outlined in the following claims.

What is claimed:

1. Compositions and products comprising water-soluble/dispersible ferric hydroxide in a strong base may be prepared:
A first aqueous solution of iron salts at a concentration ranging preferably from 10 to 80% by weight, more preferably from 20 to 70%, most preferably from 30 to 60%, wherein the water-soluble iron salts may include iron chloride, iron sulfate, and iron nitrate; a second aqueous solution of small organic molecules containing one or more hydroxyl and/or carboxylic functional groups at a concentration ranging preferably from 10 to 80% by weight, more preferably from 20 to 80%, most preferably from 40 to 80%, wherein the small organic molecules include hydroxyl acetic acid, tartaric acid, ascorbic acid, and gluconic acid; a third aqueous solution of a strong base at a concentration ranging preferably from 10 to 60% by weight, more preferably from 20 m to 50%, most preferably from 30 to 50%, wherein the strong base includes sodium hydroxide, potassium hydroxide, and lithium hydroxide; the first solution is mixed with the second solution in a molar ratio preferably from 1:10 to 10:1, more preferably from 1:5 to 5:1, most preferably from 1:2 to 2:1; the third solution is allowed to react with the above mixture to afford water-soluble and/or dispersible ferric hydroxide in a strong base.

2. The compositions and products in claim 1 may be injected into a liquid stream contaminated with hydrogen sulfide to raise the pH of the liquid stream and to reactively remove hydrogen sulfide without concerns for excessive solid production in the liquid stream.

3. The compositions and products in claim 1 may be incorporated into solid substrates, preferably biobased substrates, wherein the biobased substrates include wood chips, wood shavings, shredded crop hulls, husks, stalks, coconut shells, and other plant-derived organic matters, to form solid scavengers. Such scavengers may be packed in a fixed bed system for the removal of hydrogen sulfide in contaminated gas streams.
